(19) United States
(12) Patent Application Publication
(10) Pub. No.: US 2009/0011174 A1
(43) Pub. Date: Jan. 8, 2009

(54) Sorptive Textile Composite

(76) Inventor: Horst Bräuer, Isselburg (DE)

Correspondence Address: STANDLEY LAW GROUP LLP, 495 METRO PLACE SOUTH, SUITE 210, DUBLIN, OH, 43017, US

(21) Appl. No.: 11/665,775

(22) PCT Filed: Sep. 5, 2005
(86) PCT No.: PCT/DE2005/001546

§ 371 Date: Mar. 26, 2008

(30) Foreign Application Priority Data
Oct. 18, 2004 (DE) 102004050862.3
Nov. 9, 2004 (DE) 102004054260.0

(51) Int. Cl. D04H 11/00; D04H 1/04; B32B 27/14; B32B 37/12

(52) U.S. Cl. 428/87; 442/417; 428/198; 156/60

(57) ABSTRACT

The invention relates to a sorptive textile composite comprising an air-permeable support for adsorber particles that, on one side, is provided with an air-permeable lining having an adhesive layer. The support is a nonwoven, into which loose adsorber particles are introduced, and the nonwoven, at least on one side, is lined with an air-permeable nonwoven.

The invention pertains to a sorptive textile composite comprising an air-permeable carrier of adsorber particles, which is provided at least on one side with an air-permeable lining with a layer of adhesive.

Flat and thus flexible textile filters are used in many different areas. Whether in aircraft construction, motor vehicle manufacturing, in medical apparatuses, or especially in air-conditioning equipment, flat textile filters prevent the passage of toxic or harmful vapors and gases.

Another example of the use of flat textile filters is for ABC safety equipment, especially ABC protective suits, which are usually provided with adsorber particles for the adsorption of chemical poisons.

Even though many different examples of sorptive textile composites have become known, they are all designed in essentially the same way with respect to structure. In or on a woven and/or knitted textile fabric, adsorber particles are bonded by means of an adhesive, and, to prevent the loss of adsorber particles, the incoming side is also provided with a lining with a layer of adhesive.

So as not to limit the air permeability of these types of textile filters too severely as a result of the application of the adhesive, the surface of the carrier is usually covered only partially with the adhesive. According to DE 40 34 798, for example, a reactive, cross-linkable adhesive based on polyurethane, which acts as a hot-melt adhesive, is melted before application to the carrier. After the application of the adsorber particles to the carrier, the carrier is cooled, and the adhesive is crosslinked by the action of atmospheric humidity and/or the moisture content of the carrier.

DE 82 08 751 describes a flat textile filter, in which adsorber particles in the form of a powder and a mixture containing a polymer binder are printed in a certain pattern onto a carrier, such as a woven cotton fabric, where the printing occupies up to 90% of the surface of the carrier layer.

Holding the adsorber particles to the top surface of a textile carrier by means of an adhesive, however, is unsatisfactory for several reasons. First, a large part of the free surface of the adsorber particles is blocked off by the adhesive used to bond the adsorber particles to the carrier, which means that this surface area is no longer available to adsorb harmful gases or vapors. This loss can be as high as 25%. In addition, the elastic properties of textile carriers are impaired by adhesives, and adsorber particles can also break out of the adhesive bond at the places where the fabric is folded and thus be lost, which means that these particles, too, are no longer available to adsorb harmful gases. When the adsorption particles are applied in this way, furthermore, the depth of active adsorption is usually quite limited, because a genuine 3-dimensional filter matrix is not usually formed.

A 3-dimensional filter matrix of this type can be achieved with a carrier consisting of a foamed plastic, which holds the adsorber particles in its structure. For this purpose, as proposed in DE 44 10 920, for example, a foamed plastic is impregnated with a paste, in which the adsorber particles are contained. The binder in the paste is dried and crosslinked at elevated temperature. Initially, only the paste is dried. Then the foamed plastic is compressed and bonded to the carrier layer. While the foamed plastic is being compressed and bonded to the textile carrier, the paste is heated at least to its crosslinking temperature for a period of time sufficient for the paste to hold the foamed plastic.

Even in processes such as this, the problem is that the free surface of the adsorber particles is decreased by the adhesive, and therefore some of the active adsorption capacity is lost.

In the known processes for producing sorptive textile composites, it must be considered an additional disadvantage that a large number of steps is usually required. A textile composite usually also must be turned over, as a result of which incorporated adsorber particles can break out of the adhesive bond and be lost. This can result in irregularities in the activity of the overall surface of a textile filter, which sharply reduces its performance.

Against this technical background, the task of the invention is to create a sorptive textile composite of the type indicated above, which is easy to manufacture and which offers not only a high filter capacity but also a high degree of air permeability.

For a sorptive textile composite comprising an air-permeable carrier of adsorber particles, which is provided at least on one side with an air-permeable lining with an adhesive layer, this technical problem is solved according to claim 1 by means of the measures that the carrier is a nonwoven fabric, that loose adsorber particles are introduced into the nonwoven fabric, and that the nonwoven fabric is lined at least on one side with an air-permeable fleece.

The inventive sorptive textile composite offers several advantages over the conventional composite.

By omitting an adhesive to bind the adsorber particles to the carrier, it is ensured that the adsorber particles remain fully active. A higher level of filter performance can therefore be obtained, or it is possible to reduce the quantity of comparatively expensive adsorber particles.

A nonwoven fabric is used as the carrier for the adsorber particles. The preferably synthetic fibers of this nonwoven fabric form a flat, comparatively loose composite by being brought together and randomly distributed without being made into a yarn beforehand. The adsorber particles are introduced into this flat composite by scattering, for example, and are held in place only by the fibers themselves, not by any additional adhesive. An air-permeable fleece lining is then provided on the incoming side, so that, even after the nonwoven fabric has been turned over, the adsorber particles are unable to escape from the nonwoven fabric, and the nonwoven fabric also acquires additional strength.

In addition to polyamide (PA) and polyester (PES) fibers, it is also possible to use other types of synthetic and/or cellulosic fibers or fiber blends as materials for the nonwoven fabric.

In a preferred exemplary embodiment of the sorptive textile composite according to the invention, the nonwoven fabric is a fiber pile fleece. In a fiber pile fleece, a thread system is incorporated in such a way that individual threads project vertically from the plane of the pile fleece at certain distances from each other. As a result, at least the incoming side can be provided with tufts or loops, closed or cut, by means of which, first, the nonwoven fabric is mechanically strengthened and consolidated and, second, a surface is formed on the incoming side into which the adsorber particles can easily penetrate, whereas, if the loops are closed, the particles can hardly ever escape from them.

By choosing a surface weight in the range of 90-120 g/m², a voluminous and preferably completely synthetic textile carrier is formed, which nevertheless has a high degree of permeability to air.

To line the carrier with the fleece, a suitable, especially a medium-viscosity adhesive is used, which does not affect the flexibility of the sorptive composite according to the invention. So that the air permeability of the composite is influenced as little as possible by the layer of adhesive, the adhesive is preferably applied in the form of dots. Strip-like or grid-like adhesive patterns, especially with narrow strips, are also possible.

The lining fleece is also preferably synthetic, consisting especially of a blend of polyamide and polyester fibers. In contrast to the voluminous carrier, however, this fleece has a surface weight in the range of 20-40 g/m².

The purpose of the sorptive textile composite according to the invention will largely determine the size and the material of the adsorber particles. The size can vary from several micrometers to the millimeter range, where, if the loops are kept closed, even larger particles such as those with a size of 0.3-1 mm can be held in place and thus be used without difficulty.

Silicic acid xerogels, metal oxides and hydroxides, especially aluminum oxide and hydroxide, molecular sieves, ion exchangers, and especially active carbon can be used as adsorbing materials. Active carbon, especially active carbon spheres, the production of which is disclosed in DE 199 30 732, and the properties of which can also be adjusted during production, are preferred. Active carbon spheres which have a plurality of micropores and a high degree of hardness are also preferred.

In a further design elaboration, it is possible to provide a mesh structure such as a mesh fabric between the fiber pile fleece and the nonwoven. By means of this mesh-like structure, the transverse strength of the textile composite is considerably improved, especially when the material for the mesh structure consists of chemical fibers like PES.

This mesh structure is intended to increase only the transverse stiffness of the textile composite; the mesh is not intended to hold the active carbon spheres in place. It is therefore preferable for the mesh width of the mesh structure to be larger than the dimensions of the active carbon spheres. The mesh width of the mesh structure is therefore preferably in the range of 3-8 mm.

In addition to the previously explained sorptive textile composite, a process for the production of a textile composite, especially with one or more of the previously described features, is also to be protected, in which, in a first process step, adsorber particles are introduced into a nonwoven fabric. For example, the particles can simply be scattered in. In an immediately following second step of the process, the incoming side where the adsorber particles are being loosely held by the fibers of the nonwoven fabric is lined with fleece.

The production process therefore has basically only two steps, which are performed in immediate succession, so that there is no need to turn the carrier with the adsorber particles over. There is no danger that the adsorber particles will fall out. Instead, they are held loosely in place in the nonwoven fabric by the fibers themselves.

The quantity of the adsorber particles can be reduced by 25% versus the quantity of conventional but adhesively bonded adsorber particles, as a result of which the textile composite according to the invention can be produced more easily and at lower cost while providing the same level of adsorption performance.

If a mesh structure is provided to increase the transverse stiffness of the textile composite, then the first step of the process will be to introduce adsorber particles into a nonwoven fabric; the second step will be to cover the nonwoven fabric with a mesh structure; and the third step will be to line the incoming side where the adsorber particles are being loosely held by the fibers of the nonwoven fabric with a fleece to hold the mesh structure.

1. Sorptive textile composite comprising an air-permeable carrier for adsorber particles, which is provided at least on one side with an air-permeable lining with an adhesive layer, characterized in that the carrier is a nonwoven fabric, in that loose adsorber particles are introduced into the nonwoven fabric, and in that the nonwoven fabric is lined on at least one side with an air-permeable fleece.

2. Textile composite according to claim 1, characterized in that the nonwoven fabric is a fiber pile fleece.

3. Textile composite according to one of the preceding claims, characterized by a fiber pile fleece with a fiber pile formation on one side.

4. Textile composite according to one of the preceding claims, characterized in that the piles are formed as closed or cut loops.

5. Textile composite according to one of the preceding claims, characterized in that the surface weight of the fiber pile fleece is in the range of 90-120 g/m².

6. Textile composite according to one of the preceding claims, characterized in that the adhesive layer of the fleece is applied in the form of dots.

7. Textile composite according to one of the preceding claims, characterized in that the fleece is formed by a mixture of polyamide and polyester fibers.

8. Textile composite according to one of the preceding claims, characterized in that the surface weight of the fleece is in the range of 20-40 g/m .

9. Textile composite according to one of the preceding claims, characterized in that the adsorber particles are formed by active carbon spheres.

10. Textile composite according to one of the preceding claims, characterized in that the size of the active carbon spheres is in the range of 0.3-1.0 mm.

11. Textile composite according to one of the preceding claims, characterized in that a mesh structure is provided between the fiber pile fleece and the nonwoven.

12. Textile composite according to one of the preceding claims, characterized in that the mesh structure consists of a chemical fiber.

13. Textile composite according to one of the preceding claims, characterized in that the mesh width of the mesh structure is larger than the dimensions of the active carbon spheres.

14. Textile composite according to one of the preceding claims, characterized in that the mesh width of the mesh structure is in the range of 3-8 mm.

15. Process for the production of a textile composite, especially according to one of the preceding claims, characterized in that, in a first step, adsorber particles are introduced into a nonwoven fabric; in that, in an immediately following second step, the incoming side where the adsorber particles are being loosely held by the fibers of the nonwoven fabric is lined with a fleece.

16. Process for the production of a textile composite, especially according to one of the preceding claims, characterized in that, in a first step, adsorber particles are introduced into a nonwoven fabric; and in that, in a second step, the nonwoven fabric is covered by a mesh structure; and in that, in a third, immediately following step, the incoming side where the adsorber particles are being loosely held by the fibers of the nonwoven fabric is lined with a fleece to bond the mesh structure together.
